(19) United States
(12) Patent Application Publication
(10) Pub. No.: US 2025/0103823 A1
(43) Pub. Date: Mar. 27, 2025

(54) ENHANCED USER INTERACTIONS

(71) Applicant: American Express Travel Related Services Company, Inc., New York, NY (US)

(72) Inventors: Robert David James Trafford, Pease Pottage (GB); Fraser George Stewart, Burgess Hill (GB)

(21) Appl. No.: 18/473,496

(22) Filed: Sep. 25, 2023

(51) Int. Cl. G06F 40/35; G06Q 30/015

(52) U.S. Cl. CPC G06F 40/35; G06Q 30/015

(57) ABSTRACT

Disclosed are various embodiments for enhancing user action recommendations. Various embodiments include a computing device that can provide enhanced user interactions. First, the user interaction application can receive a conversation request. Next, the NLP application can process and analyze the conversation between an agent and a user. Next, the speech-to-text can transcribe the call and generate a transcript. The intent of the user can be interpreted from the transcript. Next, the intent is stored in the data. Finally, one or more recommendations are generated and displayed on the user interface of the agent device.

### BACKGROUND

Financial institutions offer a variety of services to their users. Users can have one or more transaction accounts (e.g., credit card accounts, charge card accounts, debit card accounts, checking accounts, money market accounts, or other demand deposit, stored value, credit accounts, etc.) with the financial institution. A user's transaction account can offer a benefit such as a concierge service or a customer support service that can be utilized by the user. When the user wants to use a service (e.g., concierge), they often have to contact (e.g., via social media, email, chat, phone, etc.) and provide information repetitively to each agent. As a result, a user is less likely to utilize the financial institutions and/or the provided services and benefits of the transaction account due to at least potential frustration, prolonged conversations, impersonal service, and/or inefficient processes.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a user interface diagram according to various embodiments of the present disclosure.

FIG. 2 is a user interface diagram according to various embodiments of the present disclosure.

FIG. 3 is a user interface diagram according to various embodiments of the present disclosure.

FIG. 4 is a drawing of a network environment according to various embodiments of the present disclosure.

FIG. 5A is a flowchart illustrating one example of functionality implemented as portions of an application executed in a computing environment in the network environment of FIG. 4 according to various embodiments of the present disclosure.

FIG. 5B is a flowchart illustrating one example of functionality implemented as portions of an application executed in a computing environment in the network environment of FIG. 4 according to various embodiments of the present disclosure.

FIG. 6A is a flowchart illustrating one example of functionality implemented as portions of an application executed in a computing environment in the network environment of FIG. 4 according to various embodiments of the present disclosure.

FIG. 6B is a flowchart illustrating one example of functionality implemented as portions of an application executed in a computing environment in the network environment of FIG. 4 according to various embodiments of the present disclosure.

FIG. 7 is a flowchart illustrating one example of functionality implemented as portions of an application executed in a computing environment in the network environment of FIG. 4 according to various embodiments of the present disclosure.

### DETAILED DESCRIPTION

Disclosed are various approaches for enhancing interactions and recommendations for users. In some embodiments, an agent of the enterprise can provide recommendations to a user based on an intent of the user. Often, when a user calls a support number or other similar number to reach a financial institution, the user is prompted through multiple questions (e.g., by an interactive voice response (IVR) system) to direct the call to the correct department within the financial institution. Often, once a user has reached a live agent, the user has to verify their identity or perform a security measure and tell the agent the reason for communicating with the live agent. In some instances, the user could send an email to a generic customer service email address of the financial institution, which can take multiple emails to resolve a user's issue/concern. A live agent of the financial institution can be reached via a phone call, online chat, social media, and other similar methods.

Once the user informs the agent of their needs, the agent often has to search through databases and/or knowledge bases of information to provide a response to the user's query. The response provided can vary from agent to agent. Furthermore, the agent could have to put the user on hold while researching the query or to form a response. Additionally, the agent could have a trouble understanding the user. Often, if the agent does not understand the user's query, the response provided is likely to lack quality. For example, a user could call the concierge service offered by the financial institution after missing a connecting flight. Due to a language barriers and/or other factors, an agent might not be able to understand and/or empathize with the user during the interaction. Additionally, the quality of the responses and/or recommendation could be impacted due to an agent managing multiple communication instances (e.g., phone calls, chats, emails, etc.) if they work in a high-volume call center or department.

In contrast, the approaches herein introduce enhanced interactions and recommendations for users. For example, embodiments of the present disclosure leverage the user profile, intent, knowledge base and/or historical data in the global customer relationship manager (CRM) to provide a personalized interaction and/or recommendation for effective communication and user satisfaction. In some examples, the recommendations can be based on the natural language processing application identifying the user's intent and generating recommendations using machine leaning and/or AI techniques.

An illustrative and non-limiting example can include a user placing a telephonic call to the concierge service phone support offered by the financial institution. As the conversation begins, the natural language processing (NLP) application can capture phrases in the conversation and identify the user's intent, such as when a user states, “book a family vacation to Italy,” and any other relevant information. The user's intent can be identified as a travel request, a shopping request, etc. based on the captured phrases. The user interaction application can integrate the user's intent with the user profile and historical data from the global CRM to generate a recommendation for the agent to offer to the user. The user interaction application can determine from the global CRM that the user prefers morning flights and likes to stay at “Hotel A,” which could be incorporated into the recommendation. The recommendation offered can state, “recommend to the user a morning flight via Airline D and a stay at Hotel A for their family trip to Italy.”

Techniques described herein for enhanced user interactions and recommendations can provide a significant technical improvement by reducing network bandwidth requirements (e.g., related to user interactions and recommendations, less phone/chat time, etc.), and improved data analysis and reporting (e.g., applying existing information for enhanced user interactions and recommendations). The techniques described herein for providing enhanced user interactions and recommendations can also provide a significant technical benefit such as streamlining user information (e.g., using a single application), providing bespoke services (e.g., recommendations tailored to user's historical data), optimized benefits and services, and/or reduced operation costs (e.g., less equipment, fewer personnel, less training time, etc.).

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

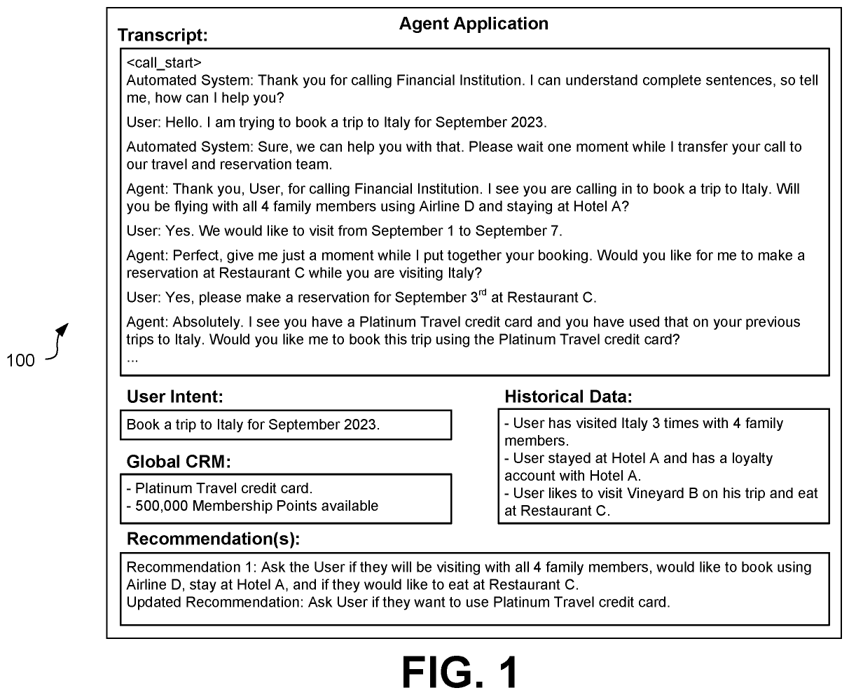

FIG. 1. 1 depicts an example of a scenario where an agent could begin interacting with a user to provide a recommendation according to various embodiments of the present disclosure. In this example, an agent can provide a recommendation(s) to the user. For example, the agent can view a transcript of the call and provide the generated recommendations based at least in part on the historical data and/or user profile.

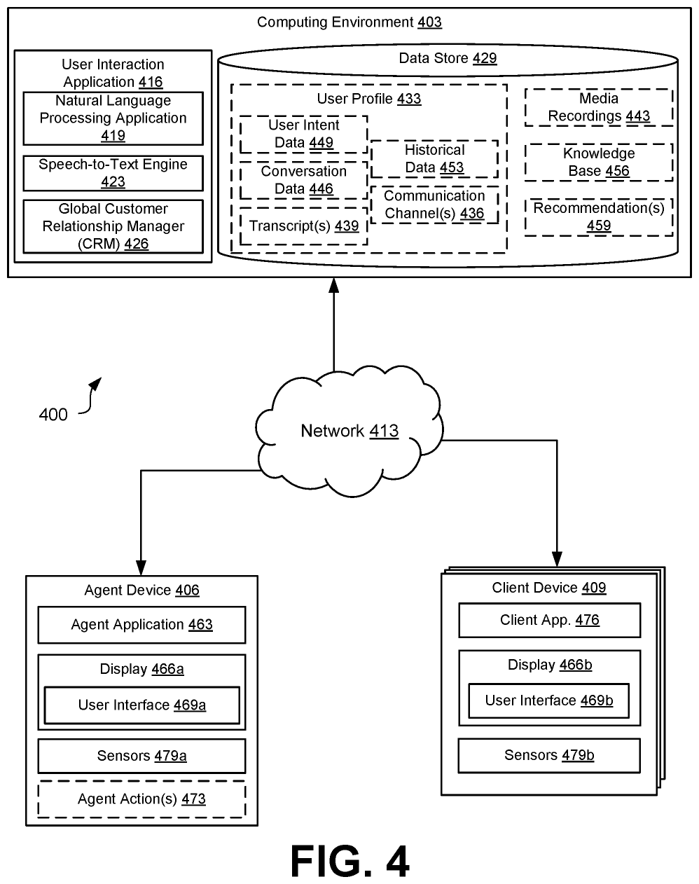

Referring to FIG. 1, shown is a user interface diagram 100 displayed on a display 466a (FIG. 4) of an agent device 406 (FIG. 4). In some instances, the user interface 469a (FIG. 4) can be rendered on the display 466a by a web browser. In other instances, the user interface 469a can be rendered and displayed on a dedicated application, a mobile application, or other related environments. The user interface 469a represents an application for interacting and providing recommendations 459 (FIG. 4) to the user. The user interface 469a can be rendered by an agent application 463 (FIG. 4).

With reference to FIG. 1, displayed is the user interface 469a of the agent application 463 on the display 466a of the agent device 406 on the user interface 469a. The agent can be presented with a transcript 439 of the conversation in real-time. In some instances, the user interface 100 can display the user intent or user intent data 449 (FIG. 4), historical data 453 (FIG. 4), the global CRM 426 (FIG. 4), the user profile 433 (FIG. 4), and/or the recommendations 459. The speech-to-text engine 423 (FIG. 4) can transcribe the call and present the text on the transcript 439 (FIG. 4). Based on the transcript, the natural language processing application 419 (FIG. 4) of the user interaction application 416 (FIG. 4) can process the conversation and determine a user intent. In some instances, the user intent can be manually input or corrected by an agent. The historical data 453 can provide information such as past travel history, merchant loyalty, favorite restaurants, and other similar historical data 453 about the user. In some examples, the user interface 100 can include a knowledge base 456 (FIG. 4) section that displays frequently asked questions or canned responses. In other embodiments, the global CRM 426 can display specific details about the user from the user profile 433. For example, the global CRM 426 can display a user's transaction account and membership reward points. In some examples, the agent application 463 (FIG. 4) can display the recommendations 459. The recommendations 459 can be updated to provide an updated recommendation 459 as the conversation progresses. For example, the first user intent is to book a trip to Italy for September 2023. The first recommendation 459 can be for an agent to ask the user if they will be travelling to Italy with their family using “Airline D” and staying at “Hotel A” for the duration of the trip. An updated recommendation 459 can be for an agent to ask the user is they want to reserve a table at “Restaurant C” and pay for the trip using the user's “Platinum Travel” credit card.

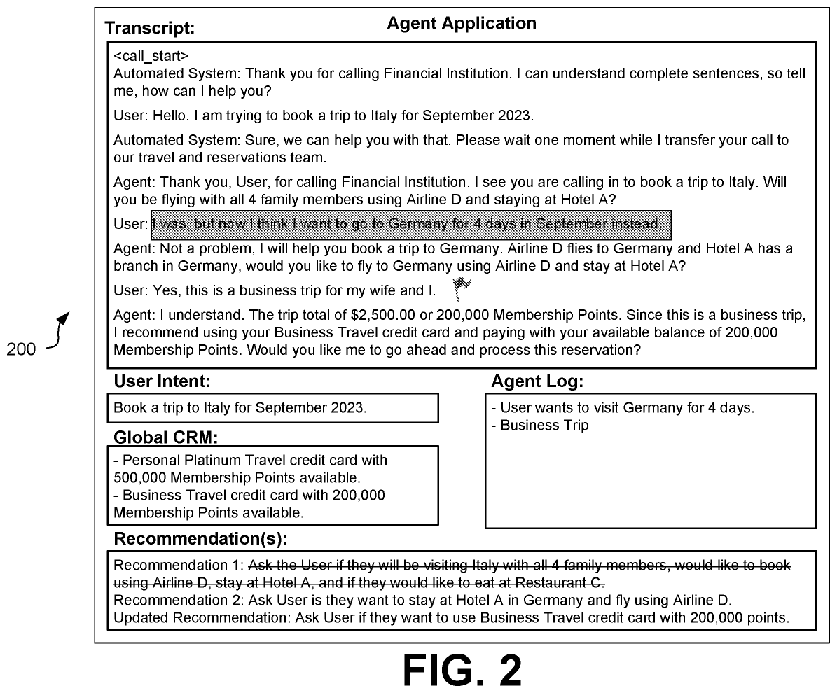

FIG. 2 depicts an example of a scenario where an agent could modify the transcript or take an action while interacting with a user to provide an updated recommendation 459 (FIG. 4) according to various embodiments of the present disclosure. In this example, an agent can provide updated recommendation(s) 459 (FIG. 4) to the user. For example, the agent can view a transcript 439 (FIG. 4) of the call and provide the generated recommendations 459 (FIG. 4) based at least in part on the historical data 453 (FIG. 4) and/or user profile 433 (FIG. 4).

Referring to FIG. 2, shown is a user interface diagram 200 displayed on a display 466a (FIG. 4) of an agent device 406 (FIG. 4). In some instances, the user interface 469a (FIG. 4) can be rendered on the display 466a by a web browser. In other instances, the user interface 469a can be rendered and displayed by a dedicated application, a mobile application, or other related environments. The user interface 469a represents an application for interacting and providing recommendations 459 to the user. The user interface 469a can be rendered by an agent application 463 (FIG. 4).

With reference to FIG. 2, displayed is the user interface 469a of the agent application 463 (FIG. 4) on the display 466a of the agent device 406 on the user interface 469a. The agent can be presented with a transcript 439 (FIG. 4) of the conversation in real-time. In some instances, the user interface 100 can display the user intent or user intent data 449 (FIG. 4), historical data 453 (FIG. 4), the global CRM 426 (FIG. 4), the user profile 433 (FIG. 4), and/or the recommendations 459 (FIG. 4). The speech-to-text engine 423 (FIG. 4) can transcribe the call and present the text on the transcript 439. Based on the transcript, the natural language processing application 419 (FIG. 4) of the user interaction application 416 (FIG. 4) can process the conversation and determine a user intent. In some instances, the user intent can be manually input or corrected by an agent. The historical data 453 can provide information such as past travel history, merchant loyalty, favorite restaurants, and other similar historical data 453 about the user. In some examples, the user interface 100 can include a knowledge base 456 (FIG. 4) section that displays frequently asked questions or canned responses.

In some embodiments, the global CRM 426 can display specific details about the user from the user profile 433. For example, the global CRM 426 can display a user's transaction account and membership reward points. In some examples, the agent application 463 (FIG. 4) can display the recommendations 459. The recommendations 459 can be updated to provide an updated recommendation 459 as the conversation progresses. For example, the first user intent is to book a trip to Italy for September 2023. The first recommendation 459 can be for an agent to ask the user if they will they travelling to Italy with their family using “Airline D” and staying at “Hotel A” for the duration of the trip. An updated recommendation 459 can be for an agent to ask the user is they want to reserve a table at “Restaurant C” and pay for the trip using the user's “Platinum Travel” credit card.

In some embodiments, the agent application 463 can have an agent log. The agent log can be used to take notes, log agent actions, and/or write information for updating the user profile 433. In some examples, the agent application 463 can include agent actions 473 (FIG. 4) such as highlighting, flagging, and an input to change the user intent data 449. For example, if an agent needs to refer to a query or phrase by a user, the agent can highlight the query or phrase in the transcript 439 (FIG. 4). In another example, the agent can place a flag or mark a query or phrase with a flag as an indicator to refer to the query/phrase or to return to it later in the conversation. In some examples, the agent can change the user intent data 449 based on the conversation.

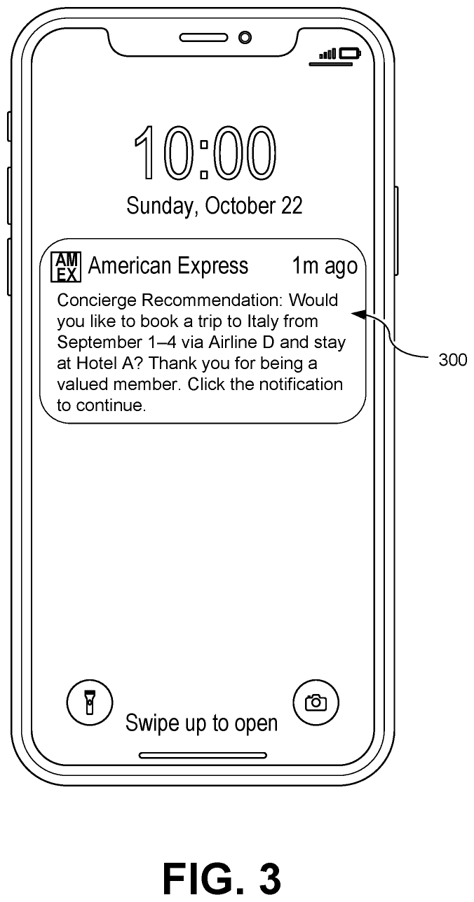

FIG. 3 depicts an example of a scenario where a user could receive a notification of a recommendation by the agent according to various embodiments of the present disclosure. In this example, an agent can provide recommendation(s) to the user. For example, the agent can view a transcript 439 (FIG. 4) of the call and provide the generated recommendations 459 (FIG. 4) based at least in part on the historical data 453 (FIG. 4) and/or user profile 433 (FIG. 4).

Referring to FIG. 3, shown is a user interface 469b displayed on a display 466b (FIG. 4) of a client device 409 (FIG. 4). In some instances, the user interface 469b (FIG. 4) can be rendered on the display 466b by a web browser. In other instances, the user interface 469b can be rendered and displayed on a dedicated application, a mobile application, or other related environments. The user interface 469b represents a notification on the client device 409, where the notification contains a recommendation 459 (FIG. 4) provided by an agent. The user interface 469b can be rendered by a client application 476 (FIG. 4).

FIG. 3 depicts a client device 409 presenting the user with a notification 300 on the user interface 469b displayed on the display 466b of the client device 409. In some examples, the notification 300 could provide the user with a recommendation 459 to book a trip. In other examples, the notification 300 could remind the user of a recommendation 459 provided by an agent. If the user selects or interacts with the notification 300, then the user could be connected with an agent of the financial institution via an individual one of the communication channels 436 (FIG. 4).

In another example, such as the example depicted in FIG. 3, the client device 409 of the user could receive a notification 300 after a conversation with an agent has been completed. The notification 300 could indicate that the agent has provided a recommendation 459. If the user initiates a conversation with the financial institution and disconnects, the user could receive a notification 300 on his or her client device 409 informing the user of the recommendation 459 provided by an agent. If the user selects or interacts with the notification 300, then the user could be proceeded to connect with an agent of the financial institution via an individual one of the communication channels 436.

As illustrated in FIG. 4, shown is a network environment 400 according to various embodiments. The network environment 400 can include a computing environment 403, an agent device 406, and a client device 409, which can be in data communication with each other via a network 413.

The network 413 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 413 can also include a combination of two or more networks 413. Examples of networks 413 can include the Internet, intranets, extranets, virtual private networks (VPNs), and similar networks.

The computing environment 403 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 403 can employ a plurality of computing devices that can be arranged in one or more server banks or computer banks or other arrangements. Such computing devices can be located in a single installation or can be distributed among many different geographical locations. For example, the computing environment 403 can include a plurality of computing devices that together can include a hosted computing resource, a grid computing resource, or any other distributed computing arrangement. In some cases, the computing environment 403 can correspond to an elastic computing resource where the allotted capacity of processing, network, storage, or other computing-related resources can vary over time.

Various applications or other functionality can be executed in the computing environment 403. The components executed on the computing environment 403 include a user interaction application 416 and other applications, services, processes, systems, engines, or functionality not discussed in detail herein. Moreover, the user interaction application 416 can contain component applications or services, such as a natural language processing (NLP) application 419, a speech-to-text engine 423, a global customer relationship manager (CRM) 426, and other component applications, services, processes, systems, engines, or functionality not discussed herein, which can be executed by the computing environment 403.

Also, various data is stored in a data store 429 that is accessible to the computing environment 403. The data store 429 can be representative of a plurality of data stores 429, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 429 is associated with the operation of the various applications or functional entities described below. This data can include user profiles 433, communication channels 436, transcripts 439, media recordings 443, conversation data 446, user intent data 449, historical data 453, knowledge base 456, recommendations 459, and potentially other data.

The one or more user profiles 433 can include data associated with a user account, such as transaction accounts, group and/or company information, and other user profile information. The one or more user profiles 433 can include access settings, such as authentication credentials, delegation settings (e.g., information about other users who can be provided access to the user profile 433 of a particular user), and/or other geographic access restrictions or limitations (e.g., information about certain locations and/or networks from which user profile 433 can be accessed). The one or more user profiles 433 can also include other account settings, such as biographical or demographic information about a user, password reset information, multi-factor authentication settings, and other data related to a user account as can be appreciated.

The one or more user profiles 433 can also include profile information about a user, authentication information about a user, applications that are installed on client devices 409 associated with the user, and/or other user information. For example, one or more user profiles 433 can include information about client devices 409 that are associated with a user, financial institution resources to which a user has access, such as customer service, dedicated account manager, concierge service, fraud services, documents, applications, or other resources.

The one or more user profiles 433 can also be dynamically updated based at least in part on user interactions, recommendations 459, conversation data 446, and other data. The user profile 433 can be used to generate recommendations 459 during user interactions. The user profile 433 can be stored in the data store 429 and/or the global CRM 426 to be accessed by an agent through a plurality of communication channels 436.

In some instances, the user profile 433 can include behavioral data, share of wallet metric, user preferences, transaction accounts, transactions, user complaints, user feedback, and other similar data. The user profile 433 could be used to predict future interactions and/or recommendations. For example, if a user takes a trip to Italy every September, the user interaction application 416 can send a notification to the client device 409 with a recommendation about a trip to Italy on a certain date in the future years (e.g., three months before the last trip date).

The transaction accounts of a user profile 433 can represent various payment accounts that can be used to make a payment from one party to another, such as from a customer or consumer to a merchant. Examples of transaction accounts can include credit card accounts, charge card accounts, debit card accounts, checking accounts, money market accounts, or other demand deposit, stored value, or credit accounts. In some implementations, individual users could have multiple transaction accounts associated with their user profile 433, such as when a user has separate transaction accounts for work and personal expenses or multiple transaction accounts to maximize rewards programs or other benefits.

The one or more transactions of a user profile 433 can represent a recorded exchange between the user and a merchant. In some embodiments, the one or more transactions can represent a deposit, a withdrawal, a transfer, or a purchase. The transaction can be linked to the transaction data. Individual transaction records can represent information associated with the one or more transactions using a transaction account. Transaction records can store relevant data such as the transaction account used to fund or pay for the transaction, the amount of the transaction, the merchant who submitted the transaction for authorization as the merchant of record, merchant type, date, transaction type, description, and other suitable transaction data elements.

The communication channels 436 can refer to the mediums through which the user can communicate with the financial institution and/or an agent of the financial institution. The communication channels 436 can be a telephone call, chat messaging, emails, social media platforms, dedicated applications, and other digital mediums. In some instances, an agent could communicate with a user on multiple communication channels 436 or handle multiple users on different ones of the communication channels 436. For example, an agent could be communication with a first user on a telephone call while simultaneously communicating with a second user through chat messaging.

In some instances, individual ones of the communication channels 436 can provide unique markers about a user. For example, a telephone call could provide insights into the user's emotion, tone, pitch, speed of talking, and other similar paralanguage markers. A chat message could provide insights into the user's typing speed, typing method (e.g., typing, speech-to-text, etc.) and other similar insights. The raw data from the individual ones of the communication channels 436 could be stored as conversation data 446. Additionally, a financial institution can benefit from having multiple communication channels 436. For example, a user could be traveling abroad where telephonic services are unavailable, but the user can use chat messaging to contact the financial institution.

The transcripts 439 can represent a text interpretation of the call or discussion between at least an agent and a user (or prospective user). In at least some embodiments, a transcript 439 can be generated by the speech-to-text engine 423 by transcribing a call or discussion from a media recording 443. In at least another embodiment, a transcript 439 can be generated by the speech-to-text engine 423 by transcribing a call or discussion as it is actively occurring. In some embodiments, emails, text messages, chat messaging, and/or other text content can be included in the transcript 439 such that a complete record of a discussion between an agent and user can be captured. A transcript 439 can be analyzed by a natural language processing application 419 to identify a user intent and help generate recommendations 459. The transcript 439 can also be analyzed by the NLP application 419 to determine valuable information during the call such as the user's intent, which can be stored as user intent data 449. In some embodiments, the transcript 439 can be representative of the statements that were made during the call. In some embodiments, the transcript 439 can identify one or more speakers to provide context to the flow of the discussion or call. In at least one example, the transcript 439 can have a first speaker identified as an agent. Similarly, the transcript 439 can have a second speaker identified as a user. In some embodiments, the transcript 439 can include a date and timestamp corresponding to when each statement was made. In some embodiments, the transcript 439 can include a time counter that marks the time that has elapsed since the start of the call or discussion. Although these time counters often measure in seconds, they could measure in minutes or other units of time. Such date and time features can be used to correlate the progress of the conversation with user intent data 449. The transcripts 439 can be modified by an agent to correct inconsistencies. The transcripts 439 could be further modified using agent actions 473.

The media recordings 443 can represent a call or a discussion between at least an agent and a user (or prospective user). The call can be a telephonic call (e.g., phone) or a video call (e.g., Teams, WebEx, Google Meet, etc.) between a user and an agent. For various compliance purposes, conversations or calls between an agent of the financial institution and a user can be recorded as media recordings 443. The media recordings 443 can be stored as various formats that can be used for playback, such as a QuickTime Movie file format (.MOV), an Audio Interleave file format (.AVI), Waveform Audio file format (.WAV), an MPEG-4 Part 14 file format (.MP4), an MPEG Audio Layer 3 file format (.MP3), a Windows® Media Video file format (.WMV), a Windows® Media Audio file format (.WMA), and/or other audio file formats.

In some instances, the media recordings 443 can be processed by the speech-to-text engine 423 to generate a transcript 439 to be analyzed by the NLP application 419. In some embodiments, the media recordings 443 can be used to train agents and/or machine learning models. The media recordings 443 can also provide other conversation data 446 and insights into the user's emotion, tone, pitch, speed of talking, and other similar paralanguage markers. The media recordings 443 could also be used as a voice biometric marker for the user and stored in the global CRM 426. In other instances, the media recordings 443 can be used to train the speech-to-text engine 423 for accuracy and other training purposes.

The conversation data 446 can represent information collected during an interaction between an agent and a user. The conversation data 446 can include data from a phone call, text message, chat messaging, emails, social media, and other communication channels 436. The conversation data 445 can include a transcript 439, a media recordings 443, notes and actions taken by an agent, and other conversation data. The conversation data 446 can be stored in the data store 429 and/or the global CRM 426. The conversation data 446 can be historical data 453. The conversation data 446 can be used to maintain a record of interactions between an agent and a user. The conversation data 446 can be used to generate the recommendations 459 provided to a user or to train a machine learning model.

The user intent data 449 can represent information extracted from the phone call, text message, chat messaging, emails, social media, and other communication channels 436 that indicates the user's purpose or intent for initiating the conversation. The user intent data 449 can be used to generate recommendations 459 and improve the user interaction. By capturing the user intent data 449, an agent is likely to be more efficient and solve user queries without prolonging the conversation. The user intent data 449 can be used to update the recommendation 459 as the conversation progresses. The user intent data 449 can be generated by the NLP application 419, which can provide a deeper understanding behind a user's words. For example, the NLP application 419 can use historical data 453 to extrapolate the meaning behind a user's specific phrases and/or words which can be used to produce user intent data 449.

The historical data 453 can represent past information and data stored from previous conversations and/or interactions between an agent and a user. The historical data 453 can include transcripts 439, media recordings 443, recommendations 459, user responses, user actions, agent actions 473, user feedback, user habits, and other similar data. The historical data 453 can be used to tailor the recommendations 459 provided to a user in the future. The historical data can be representative of a user's journey with the financial institution, including how often a user contacts the financial institutions, frequented travel itineraries and merchants, and/or a user's investment with the financial institution. The agents can utilize the historical data 453 to modify the generated recommendation 459. The historical data 453 can be analyzed to detect habits and/or patterns of a user. The habits and/or patterns can be analyzed to provide the recommendations 459 to a user.

The knowledge base 456 can represent a repository of information created by the financial institution. The knowledge base 456 can contain company policies, product/offering details, frequently asked questions, scripts, canned responses, and/or other useful information. In some instances, the information contained in the knowledge base 456 can vary depending on the user. For example, a supervisor/manager could have access to information that is unavailable to an agent or a user. In other instances, the knowledge base 456 can be user facing and contain only non-confidential information. The knowledge base 456 can be utilized to generate recommendations 459 and/or provide an agent with insights or information to progress a conversation and/or interaction with the user. The knowledge base 456 can be updated on a periodic basis (e.g., daily). In some instances, the knowledge base 456 can contain real-time feeds to provide user real-time pricing or knowledge about a product.

The recommendations 459 can be actions and/or insights generated and provided to an agent during a conversation with a user. The recommendations 459 can be generated based at least in part on the user profile 433, transcripts 439, conversation data 446, user intent data 449, historical data 453, knowledge base 456, and or previous recommendation 459. The recommendations 459 can be generated in real-time as the conversation progresses. In other instances, the recommendations 459 can be updated based on one or more agent actions 473. The recommendations 459 can be provided on a user interface 469a on the display 466a of the agent device 406. The recommendation 459 can be used by an agent to guide the conversation or recommend the next best action to a user. The recommendations 459 can be offered to solve a user's issue, provide information, upsell a product offered by the financial institution, or provide a personalized offer to a user. The recommendations 459 can be stored in the global CRM for future use or as a part of the historical data 453.

The user interaction application 416 can be executed to manage interactions between a user and an agent. The user interaction application 416 can contain subcomponents such as the NLP application 419, speech-to-text engine 423, and/or the global CRM 426. The customer interaction application 416 can be used to provide a streamlined interaction and bespoke recommendations 459. The user interaction application 416 can improve efficiency, effectiveness, and quality of user interactions with an agent. The user interaction application 416 can use the NLP application 419 to understand a user intent expressed during a conversation, such as the user's intent for initiating the conversation. During the conversation, the user interaction application 416 can use the speech-to-text engine 423 to transcribe the conversation in real-time. The user interaction application 416 can generate recommendation 459 for the user.

The natural language processing application 419 can be executed to identify contextual nuances or a user intent in the text of a transcript 439 and/or a media recording 443. The NLP application 419 can be trained using various transcripts 439 of historical calls, historical data 453, and/or conversation data 446. The NLP application 419 can use various techniques to identify and analyze the transcripts 439, such as syntactical analysis, lexical semantic analysis, relational semantic analysis, discourse and intent analysis, summarization, and other types of natural language processing analysis. The NLP application 419 can receive a request from the user interaction application 416 to analyze a transcript 439 and/or identify a user intent within a transcript 439. The NLP application 419 can analyze the transcript 439 to separate portions of the text into different categories or topics. The natural language processing application 419 can also receive historical data 453, a user profile 433 and/or a transcript 439 to subsequently identify user intent within the transcript 439. The natural language processing application 419 can identify what qualifies as user intent data 449 based on a regular expression or based on a natural language description of the intent. A confidence score can be some numeric value or combination of one or more numeric values. For example, a percentage or a decimal can be used to represent a confidence score. In some instances, the confidence score can be used by an agent to in a decision-making process (e.g., questions to ask, phrasing of questions, itinerary details, etc.). In some other embodiments, the confidence score can be used to determine reliability of the identified user intent or the user intent data 449. In some instances, if the confidence score is lower than a preset amount, the NLP application 419 can reprocess and analyze the transcript 439 to determine another user intent. The NLP application 419 can also be trained using the confidence scores to predict the user intent.

The speech-to-text engine 423 can be executed to convert the media recordings 443 into written text, often times into a transcript 439. The speech-to-text engine 423 can transcribe speech into a transcript using automatic speech recognition models, AI models, and/or machine learning techniques. The speech-to-text engine 423 can transcribe a conversation in real-time between an agent and a user. The speech-to-text engine 423 can be trained using media recordings 443, transcripts 439, and other conversation data 446. The text transcribed by the speech-to-text engine 423 can be stored in the data store 429. In some instances, the accuracy of the text transcribed by the speech-to-text engine 423 can be given a confidence score. The confidence score can be some numeric value or combination of one or more numeric values. For example, a percentage or a decimal can be used to represent a confidence score.

The global CRM 426 can be executed to manage individual user profiles 433 of respective users. The global CRM 426 can store data about a user such as the user profile 433, previous recommendations 459, and media recordings 443. In some instances, the global CRM 426 can store user information such as transaction accounts, transactions, previous interactions, and other similar information. The global CRM 426 can receive a request from the user interaction application 416 and/or the agent application 463 on the agent computing device 406 to provide the user profile 433. In some implementations, the global CRM 426 can be integrated with the speech-to-text engine 423 and the NLP application 419 to provide an improved interaction and/or recommendation 459.

The agent device 406 is representative of a device that can be coupled to the network 413. The agent device 406 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The agent device 406 can include one or more displays 466a, such as liquid crystal displays (LCDs), gas plasma-based flat panel displays, organic light emitting diode (OLED) displays, electrophoretic ink (“E-ink”) displays, projectors, or other types of display devices. In some instances, the display 466a can be a component of the agent device 406 or can be connected to the agent device 406 through a wired or wireless connection. In some instances, the agent device 406 can include one or more sensors 479a, such as a location detection unit, an accelerometer, a gyroscope, a camera, fingerprint sensor, iris sensor, and other suitable sensors.

Additionally, in some examples, the sensors 479a can be used for dynamically determining layout of the user interfaces rendered on the display 466a. For instances, text and/or graphics relocated based at least in part on a detected orientation (e.g., portrait or landscape) of the display 466a on the agent device 406. The text and graphics can be dynamically relocated based on detected gestures (via a touchscreen display) on the display 466a. The text and graphics can be dynamically relocated in order to create viewable area in the display 466a for other related text and/or graphics.

Various data is stored in a data store that is accessible to the agent device 406. The data stored in the data store is associated with the operation of the various applications or functional entities described below. This data can include agent actions 473 and potentially other data.

The agent actions 473 can include actions taken by an agent during the conversation. The agent actions can include flagging, highlighting, or providing corrections. For example, an agent can flag a statement by the user to remember to come back to that statement and/or review it after the end of the conversation. In other examples, an agent can highlight a statement in the transcript 439 that the agent deems to be important. In other examples, the agent can correct a transcription provided by the speech-to-text engine 423. In some embodiments, the actions performed by an agent, including inputs, mouse clicks, resources and/or tools used can be recorded. The captured actions can be analyzed and/or stored. The captured actions can also be used to train a machine learning model to provide improved recommendations 459.

The agent device 406 can be configured to execute various applications such as an agent application 463 or other applications. The agent application 463 can be executed on the agent device 406 to access network content served up by the computing environment 403 or other servers, thereby rendering a user interface 469a on the display 466a. To this end, the agent application 463 can include a browser, a dedicated application, or other executable, and the user interface 469a can include a network page, an application screen, or other user mechanism for obtaining user input. The agent device 406 can be configured to execute applications beyond the agent application 463 such as email applications, social networking applications, word processors, spreadsheets, or other applications.

Additionally, the agent application 463 can be executed to interface with the user interaction application 416. The agent application 463 can be used to display user interfaces for the user interaction application 416 and provide data to the NLP application 419, the speech-to-text engine 423, and/or the global CRM 426 related to the enhancement of user interactions.

The client device 409 is representative of a plurality of client devices that can be coupled to the network 413. The client device 409 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 409 can include one or more displays 466b, such as liquid crystal displays (LCDs), gas plasma-based flat panel displays, organic light emitting diode (OLED) displays, electrophoretic ink (“E-ink”) displays, projectors, or other types of display devices. In some instances, the display 466b can be a component of the client device 409 or can be connected to the client device 409 through a wired or wireless connection. In some instances, the client device 409 can include one or more sensors 479b, such as a location detection unit, an accelerometer, a gyroscope, a camera, fingerprint sensor, iris sensor, and other suitable sensors.

The sensor 479b can be used for determining which communication channels 436 are available to the client device 409 based on the location of the client device 409. Additionally, in some examples, the sensor 479b can be used for determining the dynamically determining layout of the user interfaces rendered on the display 466b. For instances, text and/or graphics relocated based at least in part on a detected orientation (e.g., portrait or landscape) of the display 466b on the client device 409. The text and graphics can be dynamically relocated based on detected gestures (via a touchscreen display) on the display 466b. The text and graphics can be dynamically relocated in order to create viewable area in the display 466b for other related text and/or graphics. In some examples, the sensors 479b could be used to capture a biometric marker of the user.

The client device 409 can be configured to execute various applications such as a client application 476 or other applications. The client application 476 can be executed in a client device 409 to access network content served up by the computing environment 403 or other servers, thereby rendering a user interface 469b on the display 466b. To this end, the client application 476 can include a browser, a dedicated application, or other executable, and the user interface 469b can include a network page, an application screen, or other user mechanism for obtaining user input. The client device 409 can be configured to execute applications beyond the client application 476 such as email applications, social networking applications, word processors, spreadsheets, or other applications.

Additionally, the client application 476 can be executed to interface with the user interaction application 416. The client application 476 can be used to display user interfaces for the user interaction application 416 and provide data to the NLP application 419, the speech-to-text engine 423, and/or the global CRM 426 related to the enhancement of user interactions.

Next, a general description of the operation of the various components of the network environment 400 is provided. Although the following description provides a general description of the interactions between the various components of the network environment 400, other interactions are also encompassed by the various embodiments of the present disclosure.

To begin, a user of a financial institution can initiate a conversation with an agent of the financial institution through a variety of communication channels The user can initiate the conversation to resolve an issue, get information, perform a transaction, use the concierge service, and other similar reasons. Often times, the users have to repeat information to an agent or be put on hold while an agent researches the issue and provides an answer. In some instances, it could be difficult for an agent to understand the user's intent for initiating the conversation due to language barriers, bad connection, or a variety of other issues, causing the effectiveness and/or quality to suffer.

When the conversation is initiated by the user, the user interaction application 416 can initiate the NLP application 419, the speech-to-text engine 423, and the global CRM 426. The speech-to-text engine 423 can start transcribing the media recording 443 of the conversation into a transcript 439. The transcript 439 can be processed and analyzed by the NLP application 419 to determine the user's intent. The NLP application 419 can use an AI model or other machine learning techniques to analyze the transcript 439 to determine a user intent. In some instances, the NLP application 419 can be used to determine at least the first speaker and the second speaker of the conversation. The NLP application 419 can correlate the portions of the transcripts to the individual ones of the speakers. The user intent can be stored as user intent data 449. The global CRM 426 can provide information about the user based at least in part on the user profile 433. For example, the global CRM 426 can detect the phone number of the user based on the data stored in the user profile 433. As the conversation is on-going, the media recording 443 can be transcribed to a transcript 439 in real-time.

After the user intent is determined, the user interaction application 416 can store the intent in the data store as user intent data 449. The user intent data 449 can be used to generate the recommendations 459. The user interaction application 416 can process and generate data required for generating a user interface for an agent of the financial institution. The user interaction application 416 can send the generated data to the agent application 463. The agent application 463 can generate and/or show the user interface. The user interface 469a is configured to display at least one of the user profile 433, the user intent data 449, the transcript 439, historical data 453, the knowledge base 456, and other similar data.

In some instances, an agent can interact with the user interface 469a by performing an agent action 473. In some examples, the agent action 473 can be highlighting, flagging, note taking, or providing corrections. For example, an agent could determine an important phrase or query in the conversation and highlight (FIG. 2) a portion of the transcript. In some other examples, an agent can flag (FIG. 2) a phrase or query in the transcript 439. In some embodiments, an agent can correct a transcript if it was transcribed incorrectly or provide a correction for the user intent. All the agent actions 473 performed by an agent can be stored in an agent log that can be stored in the global CRM 426 or the user profile 433. In some examples, the agent log can be used to train the NLP application 419 or the speech-to-text engine 423.

As the conversation is proceeding, the user interaction application 416 can continuously update the recommendation 459. For example, a user could have initiated the conversation to book a trip to Italy. The first recommendation could instruct an agent to ask the user “if they will be visiting Italy with all four family members and staying at Hotel A while in Italy.” However, if the user changed their mind while on the call with an agent, to book to trip to Germany instead, the recommendation 459 can be updated based on the new intent and could be updated to instruct the agent to ask the user “if they want to fly to Germany on Airline D and stay at a branch of Hotel A.” Providing the next best action for the user can reduce call times and increase user satisfaction.

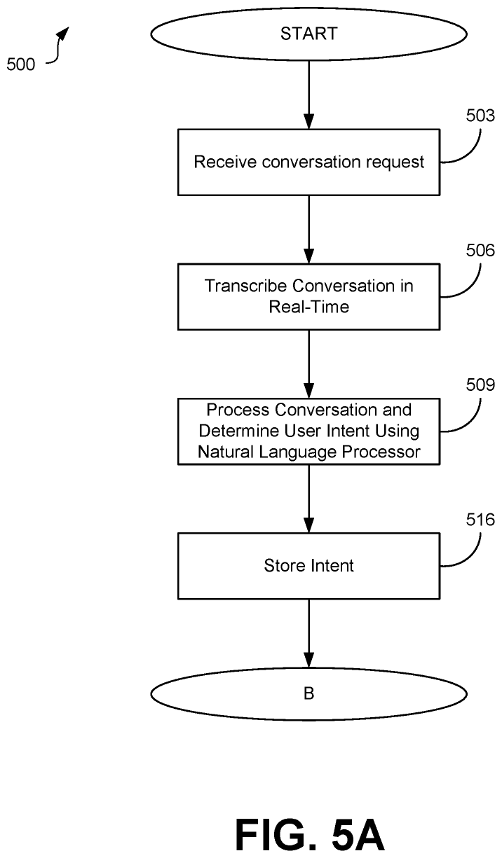

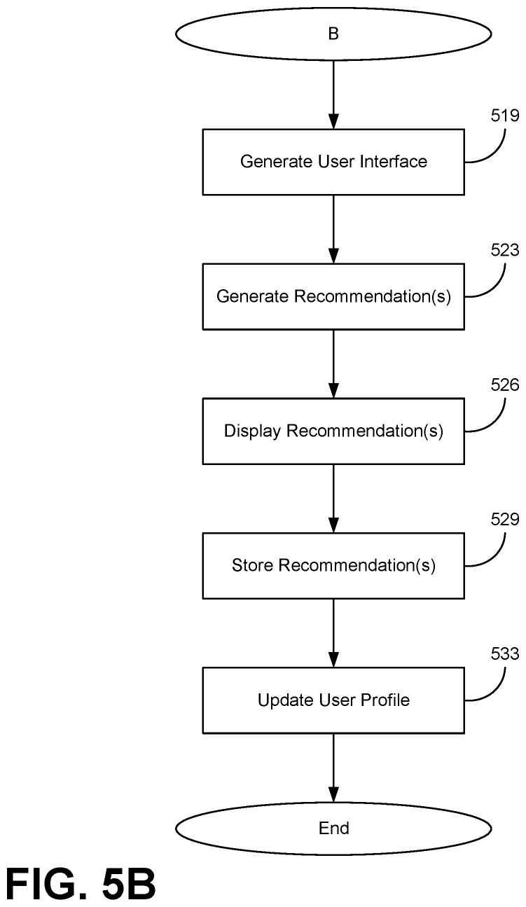

Referring next to FIGS. 5A and 5B, shown is a flowchart that provides one example of the operation of a portion of the user interaction application 416. The flowchart of FIGS. 5A and 5B provides merely an example of the many different types of functional arrangements that can be employed to implement the operation of the depicted portion of the user interaction application 416. As an alternative, the flowchart of FIGS. 5A and 5B can be viewed as depicting an example of elements of a method implemented within the network environment 400.

Beginning with block 503, the user interaction application 416 can receive a conversation request from a user. The conversation request can be made by the user via an individual one of the plurality of communication channels 436. In some examples, the user could place a telephonic call to the financial institution to initiate a conversation. In other instances, the user could initiate a conversation with the financial institution via a dedicated application or a client application 476. In some instances, the user interaction application 416 can activate the speech-to-text engine 423 and/or the NLP application 419 upon receiving a conversation request, as to capture the conversation in real-time.

At block 506, the user interaction application 416 can transcribe the conversation between at least a first speaker and a second speaker in real-time using the speech-to-text engine 423. The conversation can be captured as a media recording 443. The speech-to-text engine 423 can transcribe the media recording 443 into a transcript 439. The speech-to-text engine 423 can be trained by transcripts 439, media recordings 443, and/or a combination of both. In some examples, the speech-to-text engine 423 can transcribe the media recording 443 and/or the conversation using an AI model and/or a machine learning technique.

At block 509, the user interaction application 416 can process the conversation using the NLP application 419. The NLP application 419 can process and analyze the conversation in real-time. The NLP application 419 can use various techniques to identify and analyze the transcripts 439, such as syntactical analysis, lexical semantic analysis, relational semantic analysis, discourse and intent analysis, summarization, and/or other types of natural language processing analysis. The NLP application 419 can use the user profile 433, historical data 453, and/or the transcript 439 to analyze the conversation. The user interaction application 416 can determine a user intent by using the NLP application 419. In some examples, the user intent can be determined based at least in part on the conversation data 446 processed by the NLP application 419. In some instances, the NLP application 419 can use the user profile 433, historical data 453, and/or the transcript 439 to determine the user intent.

At block 516, the user interaction application 416 can store the user intent or the user intent data 449 in the data store. In some instances, the user intent or the user intent data 449 can be stored in the global CRM 426. The user intent data 449 can be used to provide modified recommendations 459. In some instances, the stored user intent data 449 can be used in to generate future recommendations 459.

At block 519, the user interaction application 416 can process and generate data required for generating a user interface for an agent of the financial institution. The data generated can include information from the global CRM 426, user information, transcripts 439, user intent, and recommendations 459. The user interaction application 416 can send the generated data to the agent application 463. The agent application 463 can generate and/or show the user interface. The user interface can display information from the global CRM 426, user information, transcripts 439, user intent, and recommendations 459. In some instances, an agent can interact with the user interface with an input device (e.g., keyboard, mouse, etc.).

At block 523, the user interaction application 416 can generate a recommendation 459 for the user. In some examples, the recommendation 459 can be the next best action provided to the user based on the user's query. The recommendations can be generated based at least in part on the user profile 433, user intent data 449, transcripts 439, historical data 453, conversation data 446, knowledge base 456, or previous recommendations 459.

At block 526, the user interaction application 416 can send the one or more generated recommendations 459 to the agent application 463. The agent application 463 can display the recommendations 459 on the user interface. An agent can communicate the generated recommendation 459 to a user.

At block 529, the user interaction application 416 can store the recommendations 459 in the user profile 433. In some instances, the recommendations 459 can be stored in the global CRM 426. In some examples, the user profile 433 can be a part of the global CRM 426. In some instances, the recommendations 459 that are stored can be used to generate recommendations 459 in the future.

At block 533, the user interaction application 416 can update the user profile 433 based at least in part on the conversation data 446. In some instances, the user profile 433 can be updated based at least in part on the user's acceptance of the recommendation 459. In some instances, the update to the user profile 433 can include new transaction accounts, transactions, interaction details, or any feedback.

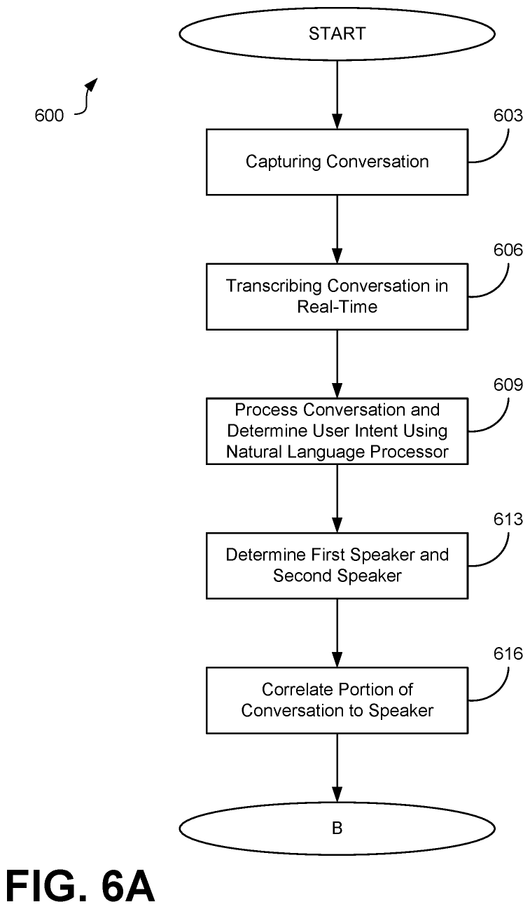

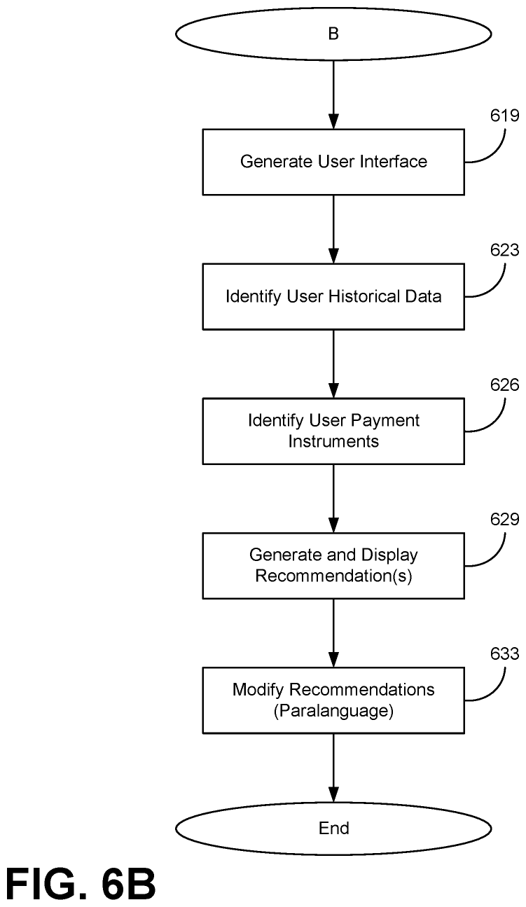

Referring next to FIGS. 6A and 6B, shown is a flowchart that provides one example of the operation of a portion of the user interaction application 416. The flowchart of FIGS. 6A and 6B provides merely an example of the many different types of functional arrangements that can be employed to implement the operation of the depicted portion of the user interaction application 416. As an alternative, the flowchart of FIGS. 6A and 6B can be viewed as depicting an example of elements of a method implemented within the network environment 400.

Beginning with block 603, the user interaction application 416 can capture a conversation. The conversation can be representative of the interaction occurring between at least a first speaker and a second speaker. The conversation can be captured in a text file or a media recording 443 based at least in part on the communication channel 436 of the conversation.

At block 606, the user interaction application 416 can transcribe the conversation between at least a first speaker and a second speaker in real-time using the speech-to-text engine 423. The conversation can be captured as a media recording 443. The speech-to-text engine 423 can transcribe the media recording 443 into a transcript 439. The speech-to-text engine 423 can be trained by transcripts 439, media recordings 443, and/or a combination of both. In some examples, the speech-to-text engine 423 can transcribe the media recording 443 and/or the conversation using an AI model and/or a machine learning technique.

At block 609, the user interaction application 416 can process the conversation using the NLP application 419. The NLP application 419 can process and analyze the conversation in real-time. The NLP application 419 can use various techniques to identify and analyze the transcripts 439, such as syntactical analysis, lexical semantic analysis, relational semantic analysis, discourse and intent analysis, summarization, and/or other types of natural language processing analysis. The NLP application 419 can use the user profile 433, historical data 453, and/or the transcript 439 to analyze the conversation.

At blocks 613 and 616, the user interaction application 416 can determine at least the first speaker and the second speaker of the conversation. In some examples, the first speaker can be an agent of the financial institution. In other examples, the second speaker can be a user. In some embodiments, the user interaction application 416 can correlate a portion of the conversation to the first speaker. In some examples, the user interaction application 416 can correlate a portion of the conversation to the second speaker. In some instances, the user interaction application 416 can label the first speaker and the second speaker on the transcript 439. In some instances, the NLP application 419 can differentiate intent of a user based on the determination of the first speaker and the second speaker.

At block 619, the user interaction application 416 can process and generate data required for generating a user interface for an agent of the financial institution. The data generated can include information from the global CRM 426, user information, transcripts 439, user intent, and recommendations 459. The user interaction application 416 can send the generated data to the agent application 463. The agent application 463 can generate and/or show the user interface. The user interface can display information from the global CRM 426, user information, transcripts 439, user intent, and recommendations 459. In some instances, an agent can interact with the user interface with an input device (e.g., keyboard, mouse, etc.).

At block 623, the user interaction application 416 can identify the historical data 453 of a user. In some instances, the identified historical data can be based at least in part on the user profile 433. In other examples, the historical data 453 can be identified based at least in part on the global CRM 426. The historical data 453 can be used to generate a personalized recommendation 459.

At block 626, the user interaction application 416 can identify a payment instrument associated with the user. In some instances, the payment instrument can be the same as the transaction accounts associated with the user. The payment instruments can be stored in the global CRM 426 or the user profile 433.

At block 629, the user interaction application 416 can generate a recommendation 459 for the user. In some examples, the recommendation 459 can be the next best action provided to the user based on the user's query. The recommendations can be generated based at least in part on the user profile 433, user intent data 449, transcripts 439, historical data 453, conversation data 446, knowledge base 456, or previous recommendations 459. The user interaction application 416 can display the recommendations 459 on the user interface. An agent can communicate the generated recommendation 459 to a user.

At block 633, the user interaction application 416 can modify the recommendation 459. In some examples, the conversation analysis module can analyze the conversation for paralanguage. The paralanguage can be the tone, pitch, speed, and other similar factors of a user's speech. The recommendation 459 can be modified based at least in part on the paralanguage.

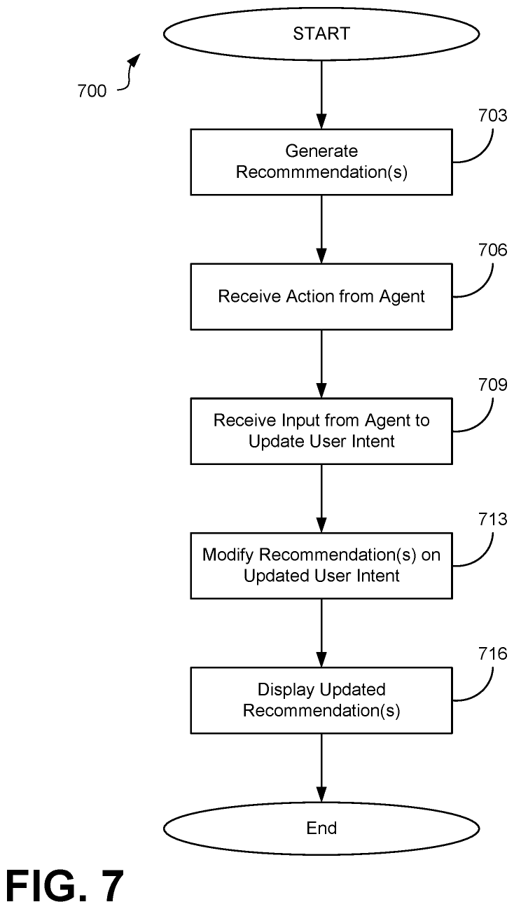

Referring next to FIG. 7, shown is a flowchart that provides one example of the operation of a portion of the user interaction application 416. The flowchart of FIG. 7 provides merely an example of the many different types of functional arrangements that can be employed to implement the operation of the depicted portion of the user interaction application 416. As an alternative, the flowchart of FIG. 7 can be viewed as depicting an example of elements of a method implemented within the network environment 400.

Beginning with block 703, the user interaction application 416 can generate a recommendation 459 for a user. In some examples, the recommendation 459 can be the next best action provided to the user based on the user's query. The recommendations 459 can be generated based at least in part on the user profile 433, user intent data 449, transcripts 439, historical data 453, conversation data 446, knowledge base 456, or previous recommendations 459. The user interaction application 416 can display the recommendations 459 on the user interface. An agent can communicate the generated recommendation 459 to a user.

At block 706, the user interaction application 416 can receive an agent action 473 from the agent device 406. In some embodiments, the agent actions 473 can be performed on the transcript 439 generated by the speech-to-text engine 423. For example, the agent actions 473 performed on the transcript 439 can include flagging portions of the transcript 439 and/or highlighting portions of the transcript 439. In some examples, the agent action 473 can include correcting the transcript. In some embodiments, the agent action 473 can include correcting the user intent data 449, the user intent, or the conversation data 446. In some embodiments, the agent actions 473 can be logged and stored in the data store 429.

At block 709, the user interaction application 416 can receive an input from the agent to update the user intent. The user intent data 449 can be updated based at least in part on the input received from an agent. The input can correct the user intent data 449 that is processed and analyzed by the NLP application 419. The updated user intent can be used to generate an updated recommendation 459 for the user.

At blocks 713 and 716, the user interaction application 416 can update the generated recommendation 459 for the user. In some examples, the updated recommendation 459 can be the next best action provided to the user based on the updated user intent. The updated recommendation can be generated based at least in part on the user profile 433, user intent data 449, transcripts 439, historical data 453, conversation data 446, knowledge base 456, or previous recommendations 459. The user interaction application 416 can display the updated recommendations 459 on the user interface. An agent can communicate the updated recommendation 459 to a user.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 403.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims. cm Therefore, the following is claimed:

1. A system, comprising:
a computing device comprising a processor and a memory; and
machine-readable instructions stored in the memory that, when executed by the processor, cause the computing device to at least:
receive a conversation request from a user of a client device;
transcribe, in real-time, a conversation to a transcript, the conversation being representative of a media recording that occurs between at least an agent and the user;
determine, using a natural language processor (NLP), an intent of the user based at least in part on the transcript;
generate one or more recommendations based at least in part on the intent of the user; and
store the intent of the user in a global customer relationship manager (CRM).

2. The system of claim 1, wherein the machine-readable instructions that transcribe the conversation further cause the computing device to at least:
process the conversation using a speech-to-text engine as conversation text;
identify a first speaker in the conversation as the user of the client device;
identify a second speaker in the conversation as the agent; and
correlate at least a portion of the conversation text with the first speaker or the second speaker to generate the transcript.

3. The system of claim 1, wherein the one or more recommendations are further based at least in part on a user profile on the global CRM and historical user data.

4. The system of claim 1, wherein the machine-readable instructions further cause the computing device, when executed by the processor, to:
identify the intent of the user as a travel request;
generate a travel recommendation based at least in part on the travel request and previous travel history; and
store the travel recommendation in the global CRM.

5. The system of claim 1, wherein the one or more recommendations are configured to change dynamically based at least in part on the conversation.

6. The system of claim 1, wherein the machine-readable instructions further cause the computing device, when executed by the processor, to analyze the conversation in real-time to measure an effectiveness of the one or more recommendations.

7. The system of claim 1, wherein the machine-readable instructions further cause the computing device, when executed by the processor, to at least:
receive an input from the agent, the input comprising at least one of a second intent of the user or additional information; and
modify the one or more recommendations based at least in part on the input.

8. The system of claim 1, wherein the machine-readable instructions further cause the computing device, when executed by the processor, to receive an action from the agent, wherein the action can comprise at least one of flagging, highlighting, or correcting a portion of the transcript.

9. A method comprising:
capturing a conversation, the conversation being representative of an interaction occurring between at least an agent and a user of a client device;
transcribing, in real-time, the conversation to a transcript;
determining, using a natural language processor (NLP), an intent of the user based at least in part on the transcript;
generating one or more recommendations based at least in part on the intent of the user; and
storing the intent of the user in a global customer relationship manager (CRM).

10. The method of claim 9, wherein transcribing the conversation further comprises:
processing the conversation using a speech-to-text engine as conversation text;
identifying a first speaker in the conversation as the agent;
identifying a second speaker in the conversation as the user of the client device; and
correlating at least a portion of the conversation text with the first speaker or the second speaker to generate the transcript.

11. The method of claim 9, wherein the one or more recommendations are configured to change dynamically based at least in part on the conversation.

12. The method of claim 9, wherein the one or more recommendations are further based at least in part on a user profile on the global CRM and historical user data.

13. The method of claim 9, further comprising:
identifying the intent of the user as a travel request;
generating a travel recommendation based at least in part on the travel request and previous travel history; and
storing the travel recommendation in the global CRM.

14. The method of claim 9, further comprising storing, in the global CRM, at least one of a plurality of actions taken by the agent during the conversation or a log of resources accessed by the agent.

15. The method of claim 9, further comprising:
analyzing the conversation for paralanguage using a conversation analysis module; and
modifying the one or more recommendations based at least in part on the paralanguage.

16. A non-transitory, computer-readable medium, comprising machine-readable instructions that, when executed by a processor of a computing device, cause the computing device to at least:
receive a conversation request from a user of a client device;
transcribe, in real-time, a conversation to a transcript, the conversation being representative of a media recording that occurs between at least an agent and the user;
determine, using a natural language processor (NLP), an intent of the user based at least in part on the transcript;
generate one or more recommendations based at least in part on the intent of the user; and
store the intent of the user in a global customer relationship manager (CRM).

17. The non-transitory, computer-readable medium of claim 16, wherein the one or more recommendations are further based at least in part on a user profile on the global CRM and historical user data.

18. The non-transitory, computer-readable medium of claim 16, wherein the machine-readable instructions, when executed by the processor, further cause the computing device to receive an action from the agent, wherein the action can comprise at least one of flagging, a highlighting, or correcting a portion of the transcript.

19. The non-transitory, computer-readable medium of claim 16, wherein the machine-readable instructions, when executed by the processor, further cause the computing device to:
identify the intent of the user as a travel request;
generate a travel recommendation based at least in part on the travel request and previous travel history; and
store the travel recommendation in the global CRM.

20. The non-transitory, computer-readable medium of claim 16, wherein the one or more recommendations are configured to change dynamically in real-time based at least in part on the conversation.
